(19) United States
(12) Patent Application Publication
(10) Pub. No.: US 2006/0162518 A1
(43) Pub. Date: Jul. 27, 2006

(54) Exact weight meat cutting device

(76) Inventors: Henry Biggs, Gallatin, TN (US); Steve Kortely, Gallatin, TN (US)

Correspondence Address: LAW OFFICES OF ADAM H. JACOBS;PATENT ATTORNEY, SUITE 726, 1904 FARNAM STREET, OMAHA, NE, 68102, US

(21) Appl. No.: 11/340,364

(22) Filed: Jan. 26, 2006

Related U.S. Application Data
(60) Provisional application No. 60/647,147, filed on Jan. 26, 2005.

(51) Int. Cl. B26D 5/00

(52) U.S. Cl. 83/75.5; 83/77; 83/932

(57) ABSTRACT

An exact weight meat cutting device includes a frame, a lower conveyor belt and an adjustably mounted upper conveyor belt extending generally parallel with and spaced from the lower conveyor belt. A scale reads the weight of the meat product and optical sensors read the width and length of the meat product as it passes through and the height of the meat product is determined by the vertical spacing of the upper and lower conveyor belts. A computer calculates the dimensions of the exact weight piece of meat product that should be cut from the remainder of the meat product by using the size and weight measurements, and the position-adjustable blade of the slicing device, which is interposed between the upper and lower conveyor belts, is positioned by the computer to cut and separate the exact weight piece from the remainder piece of the meat product.

### CROSS-REFERENCE TO RELATED PROVISIONAL PATENT

This application claims priority based on a provisional patent, specifically on the Provisional Patent Application Ser. No. 60/647,147 filed Jan. 26, 2005.

### BACKGROUND OF THE INVENTION

1. Technical Field

The present invention relates to meat weighing and cutting devices and, more particularly, to an exact weight meat cutting device which includes a frame, a main and an upper pressing conveyor belts to compress the meat product therebetween, a weight measurement device such as a scale positioned adjacent and immediately below the forward end of the main conveyor belt to weigh meat product placed on the main conveyor belt, at least two laser displacement sensors mounted on opposite sides of the main conveyor belt for measuring the width and length of the meat product, a programable computer system connected to the laser displacement sensors and scale operative to form a three-dimensional image of the meat product and determine the precise cutting location on the meat product to obtain a slice of predetermined weight and a cutting device vertically adjustably mounted on the frame intermediate the main and upper pressing conveyor belts for cutting the meat product as the meat product passes through the device.

2. Description of the Prior Art

The meat packing industry has numerous types of slicing and cutting devices each designed to perform a specific function such as cutting a particular type of meat product or removing or separating one type of meat product from another during processing of the carcass. The vast majority of these devices, however, do not include any mechanism by which the size of the resulting meat product may be determined, and particularly do not include any mechanism by which the weight of the resulting meat product may be predetermined and set by the operator of the machine to produce a series of meat product slices from successive meat products which have generally identical weights. Some devices have been proposed in the prior art which attempt to address and solve this particular problem, including Akesson et al., U.S. Pat. No. 4,868,951, Helsene et al., U.S. Pat. No. 4,662,029, and Newman, U.S. Pat. No. 5,668,634. Each of the cited prior art devices, however, include inherent deficiencies which do not completely eliminate the difficulties encountered by one attempting to process and create a meat product section having an exact weight. Furthermore, to a large extent, these prior art devices remain labor-intensive, and as the intention of such devices should be to decrease the amount of labor needed to produce the meat product, these devices are deficient in this aspect. There is therefore a need for an exact weight meat cutting device which is safe and economical in operation and produces quality exact weight cuts of meat in a rapid and efficient manner.

It should also be noted that many of the devices found in the prior art which ostensibly teach towards exact weight meat cutting devices require substantial pre-processing of the meat product in order to ensure that the meat product is of uniform size, shape, and weight before being cut into selected weight amounts. It is clear that such an amount of pre-processing merely switches the labor from after the use of the device to before the use of the device, and thus presents little, if any, reduction in the amount of labor and time needed to produce an exact weight meat product. There is therefore a need for an exact weight meat cutting device which is capable of accepting cuts of meat which have differing sizes, shapes, and weights, and processing each of them regardless of the starting values to produce a finished exact weight meat product.

Therefore, an object of the present invention is to provide an exact weight meat cutting device which will automatically accept and process a meat product to produce an exact weight finished meat cut.

Another object of the present invention is to provide an exact weight meat cutting device which includes a frame, upper and lower conveyor belts cooperating to secure and move the meat product forward therebetween, a scale for weighing the meat product, measurement devices for measuring the width of the meat product, a measurement device for the height of the meat product, a computing device operative to compute the volume of the meat product, and an adjustment device for adjusting the height of the cutting blade relative to the meat product to produce a cut of meat having an exact weight predetermined by the user of the invention.

Another object of the present invention is to provide an exact weight meat cutting device which does not require significant pre-processing of the meat product prior to use of the device, specifically regarding the height, width, and length dimensions and weight of the meat product, as each of these factors are taken into account by the exact weight meat cutting device of the present invention.

Another object of the present invention is to provide an exact weight meat cutting device which includes a separator plate extending rearwards of the end of the lower conveyor belt to keep the upper and lower slices separated for further processing of those sections.

Another object of the present invention is to provide an exact weight meat cutting device which includes an easily programmable computing device which will produce specific cuts of meat having exact weights as determined by a user of the present invention.

Another object of the present invention is to provide an exact weight meat cutting device which does not require highly specialized skills or training in order to operate the device properly.

Finally, an object of the present invention is to provide an exact weight meat cutting device which is relatively simple and durable in design and operation and is safe, effective, and efficient in use.

### SUMMARY OF THE INVENTION

The present invention provides an exact weight meat cutting device including a frame, a lower conveyor belt mounted on the frame and having a forward end and a rearward end and an upper conveyor belt height-adjustably mounted on the frame and extending generally parallel with and spaced above the lower conveyor belt. A weighing device such as a scale is mounted on the frame adjacent the forward end of the lower conveyor belt operative to weigh meat product placed on the lower conveyor belt and at least two displacement sensors are mounted on the frame on opposite sides of the lower conveyor belt, each of the at least two displacement sensors operative to incrementally read the distance between each of the at least two displacement sensors and an adjacent side of a meat product when the meat product on the lower conveyor belt passes between the at least two displacement sensors. The lower conveyor belt and the upper conveyor belt cooperate to transport the meat product through the exact weight meat cutting device towards the rearward end of the lower conveyor belt. A computing device is in information transmission connection with the weighing means and the at least two displacement sensors, the computing device operative to receive the weight of the meat product, the height between the upper and lower conveyor belts and the incremental distance readings from the at least two displacement sensors and compute the volume of the meat product via calculation of width times length times height for each incremental section of the meat product. The computing device is further operative to determine the amount of meat product which will be cut from the meat product to produce a remainder piece and an exact weight piece, the exact weight piece of the meat product having a selected weight as desired by a user of the exact weight meat cutting device. A meat product slicing device is positioned intermediate the forward and rearward ends of the lower conveyor belt, the meat product slicing means including position-adjustable blade means, the position-adjustable blade means interposed between the upper conveyor belt and the lower conveyor belt and operative to separate the exact weight piece from the remainder piece of the meat product. The computing device is also operatively connected to the meat product slicing means to adjust the positioning of the position-adjustable blade means between the upper conveyor belt and the lower conveyor belt to separate the exact weight piece from the remainder piece of the meat product as determined by the computing means. Finally, the lower conveyor belt and the upper conveyor belt further cooperate to transport the meat product through the exact weight meat cutting device into contact with and past the adjustable blade means towards the rearward end of the lower conveyor belt whereby the meat product is sliced into the exact weight piece and the remainder piece.

The present invention addresses and corrects many of the disadvantages found in the prior art. For example, the use of the exact weight meat cutting device will greatly reduce waste and inefficiency in the production of meat products as exact weight slices of meat can immediately taken from the device and wrapped for distribution to the consumer without requiring further processing. Furthermore, because the final weight of the exact weight meat product may be easily changed by use of the computing device, it is a simple matter to produce many different weights of meat cuts depending on the desires of the end consumer. Also, as the present invention is designed for use with many different meat product types, including meat, chicken, pork, fish, etc., it can be used in many different packing plants in many different situations. Finally, as the exact weight meat cutting device of the present invention performs the measurement, separation, and removal of the exact weight slice in one device via one continuous operation, the processing of the meat product to produce the exact weight slice is performed without slowing or impeding the processing line. It is therefore seen that the present invention provides a substantial improvement over those devices found in the prior art.

### BRIEF DESCRIPTION OF THE DRAWINGS

FIG. 1 is a perspective view of the exact weight meat cutting device of the present invention;

FIG. 2 is a detailed top plan view of the present invention showing a meat product being measured for width and length to create the three dimensional image of the meat product within the computing device;

FIG. 3 is a detailed end elevational view of the present invention showing the meat product immediately prior to cutting;

FIG. 4 is a side elevational view of the present invention showing the location of the various elements therein; and

FIGS. 5, 6 and 7 are respectively, perspective, side and side elevational views of an alternative embodiment of the present invention showing the top slice and bottom piece of the meat product being transferred for further processing.

### DESCRIPTION OF THE PREFERRED EMBODIMENT

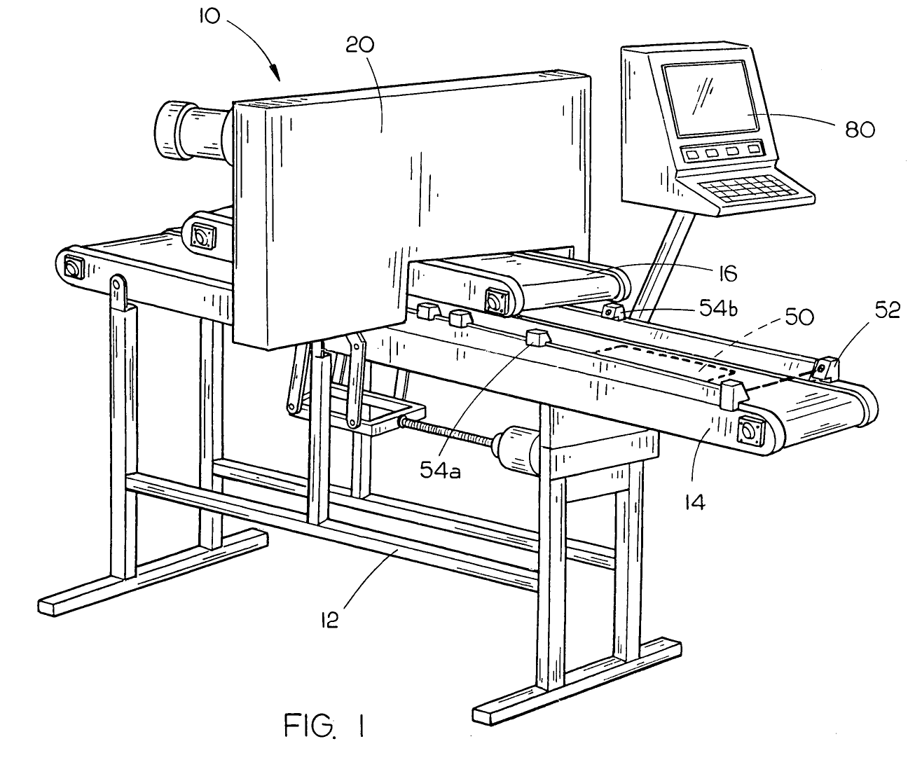

The exact weight meat cutting device 10 of the present invention is shown best in FIGS. 1-6 as including a frame 12 on which the device 10 rests, a main conveyor belt 14 extending generally horizontally on the frame 12 and an upper pressing conveyor belt 16 adjustably mounted above and extending generally parallel with the main conveyor belt 14. In the preferred embodiment, the main and upper pressing conveyor belts 14 and 16 would have lengths of approximately three feet to seven feet, with the main conveyor belt 14 extending forwards of the upper pressing conveyor belt 16 to facilitate the placement of meat product thereon. In fact, main conveyor belt 14 would extend a substantial distance in front of upper pressing conveyor belt 16, as it is the forward end 18 of main conveyor belt 14 on which the initial weighing of the meat product 100 will take place.

In the preferred embodiment, the main conveyor belt 14 would be a variable speed conveyor and would further include a weight measurement device 50 such as an electronic scale mounted adjacent the forward end of main conveyor belt 14 directly underneath the main conveyor belt 14 to weigh meat product 100 placed on the main conveyor belt 14. An optical incremental encoding device 52 also is positioned at the forward end 18 of main conveyor belt 14 which works in conjunction with the weighing device 50 to identify the particular piece of meat product 100 which has been placed on the main conveyor belt 14 and track it as it passes through the exact weight meat cutting device 10 of the present invention. The proper tracking of each meat product 100 passing through the exact weight meat cutting device 10 of the present invention is important to ensure that the cutting of the meat product 100 is performed in a manner befitting the particular meat product 100 passing through the device, specifically that each meat product 100 has its own unique cutting location to produce the finished meat product, therefore the exact weight meat cutting device 10 of the present invention must be aware of which particular meat product 100 on main conveyor belt 14 is about to be cut. The optical incremental encoding device 52 provides this information to the computing device 80 which is mounted on frame 12 adjacent the main conveyor belt 14, as shown best in FIG. 1.

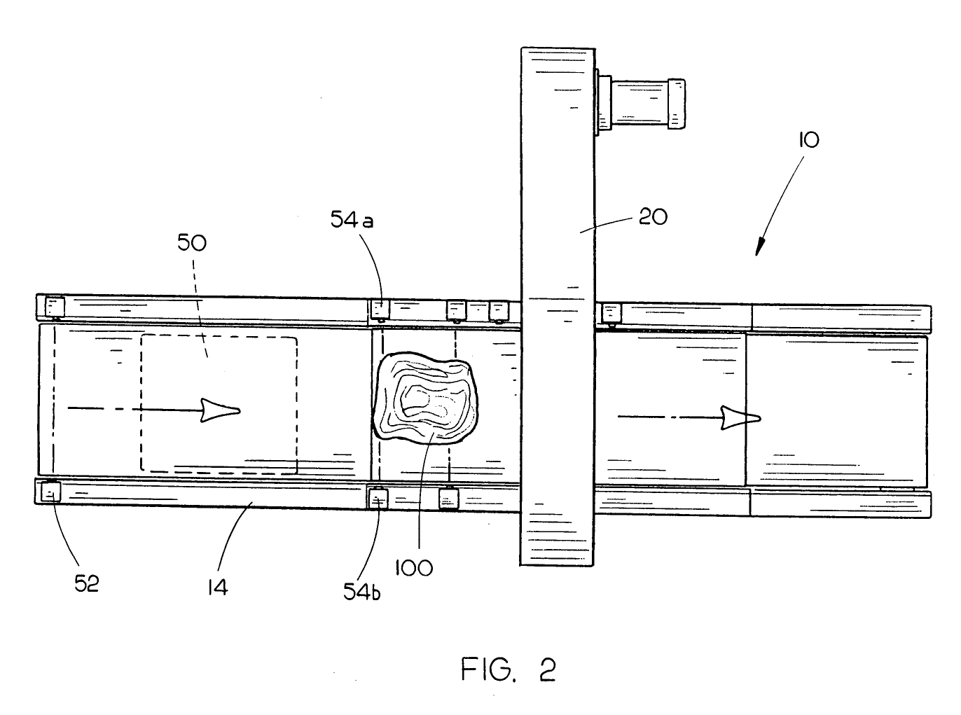

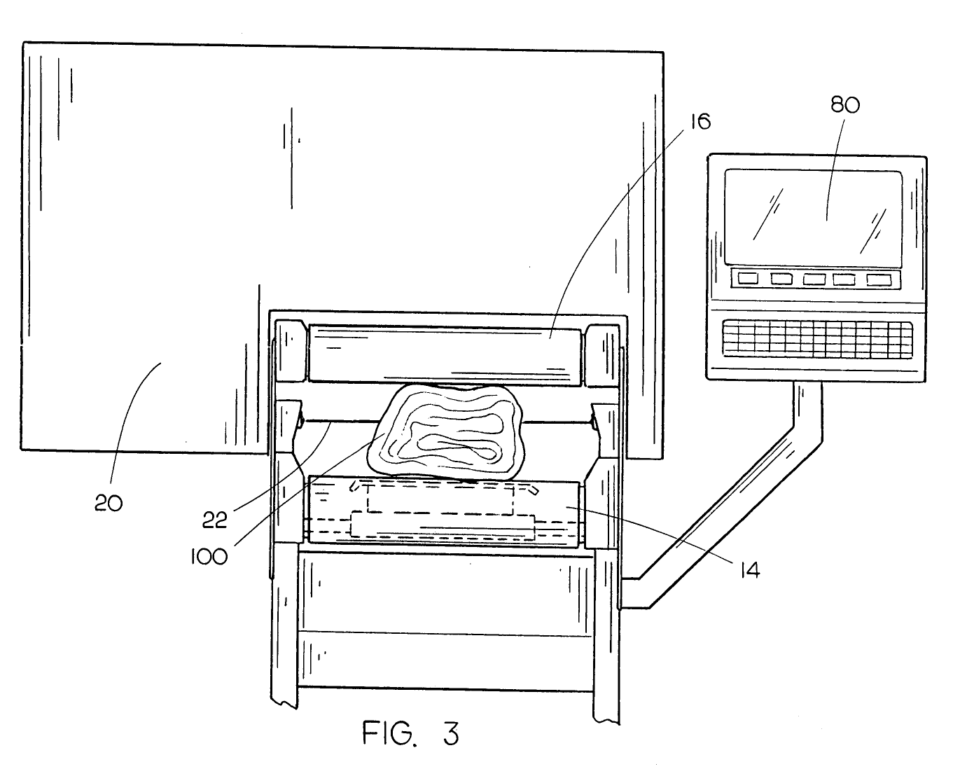

Once the weight of the meat product 100 has been determined by weighing device 50, and that information has been transferred to the computing device 80, the meat product 100 is moved into the exact weight meat cutting device 10 via main conveyor belt 14, as shown best in FIGS. 2 and 3. At this point, the meat product 100 is compressed between the main conveyor belt 14 and upper pressing conveyor belt 16. The compression of the meat product 100 between the main conveyor belt 14 and upper pressing conveyor belt 16 serves two purposes, the first being to compress and secure the meat product 100 prior to cutting thereof to prevent slippage or twisting of the meat product 100 during the cutting process. Second, the exact height of the meat product 100 can now be determined as the distance between the main conveyor belt 14 and upper pressing conveyor belt 16 is known. This height is sent to the computing device 80 for further computation and the meat product 100 is moved forwards between the main conveyor belt 14 and upper pressing conveyor belt 16.

Mounted on opposite sides of the main conveyor belt 14 are a pair of laser displacement sensors 54a and 54b which point across the main conveyor belt 14 perpendicular to the main conveyor belt 14. Each of these laser displacement sensors 54a and 54b are operative to return a distance reading when it encounters a solid object passing in front of the laser, similar in operation to laser range-finding devices with modifications for accuracy and distance for use with the present invention. When no meat product is passing through the exact weight meat cutting device 10, each laser displacement sensor 54a and 54b reads the distance from one side of the main conveyor belt 14 to the other. However, as a meat product 100 is moved into the exact weight meat cutting device 10 of the present invention, each of the laser displacement sensors 54a and 54b identify the leading edge of the meat product 100 as it passes between the laser displacement sensors 54a and 54b, thus identifying the beginning section of the meat product 100 and simultaneously beginning to read the distance from the adjacent side of the meat product 100 to the particular laser displacement sensors 54a and 54b positioned on opposite sides of the main conveyor belt 14. The laser displacement sensors 54a and 54b then signal the computing device 80 to tell the computing device 80 that the meat product 100 is passing in front of the laser displacement sensors 54a and 54b, and the computing device 80 thus begins to measure the length of the meat product 100 which may be determined either by the length of time the meat product 100 passes in front of the laser displacement sensors 54a and 54b multiplied by the speed of the main conveyor belt 14 to derive the length of the meat product 100 or by measuring the number of measurements taken by each of the laser displacement sensors 54a and 54b as will be described immediately hereafter. The laser displacement sensors 54 as and 54b take measurements at approximately one millimeter intervals which determine the width of the meat product 100, thus forming a three-dimensional representation of the shape of the meat product 100 and also producing a length measurement for the meat product 100. This process continues until the rear end of the meat product 100 passes the laser displacement sensors 54a and 54b which then signal the computing device 80 that the end of the meat product 100 has been reached. The computing device 80 then computes the width, length, and height of the meat product 100, thus permitting the volume of the meat product 100 to be derived through a simple calculation of width times length times height for each one millimeter section, then adding the volumes together to obtain the total volume of the meat product 100. It is important to note that the vast majority of meat products 100 passing through the exact weight meat cutting device 10 of the present invention will not have regular widths due to the inherent differences between various types of meat products. However, the approximation produced by measurements of the width of the meat product 100 approximately every millimeter along the length of the meat product 100 results in a fairly specific three-dimensional representation of the height, width, and length of the meat product being produced, which may be used by the computing device 80 to produce an accurate value for the volume of the meat product 100.

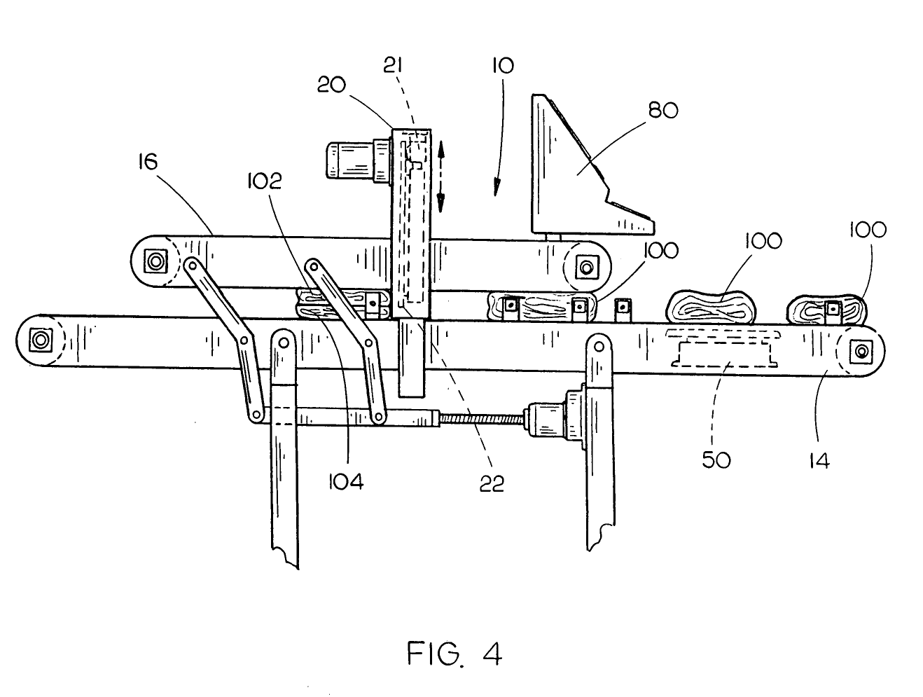

Once the measurements for the meat product 100 have been input into the computing device 80, the computing device 80 via its software programming calculates the volume of the meat product 100 and determines the amount of meat product 100 which will be cut from the top of the meat product 100 to produce a top slice 102 and a bottom piece 104, the bottom piece 104 of the meat product having the exact weight predetermined by the exact weight meat cutting device 10 as desired by the operator of the present invention. Once the computing device 80 has calculated the amount which must be removed from the meat product 100 to produce the exact weight bottom piece 104, that information is transferred to the cutting blade assembly 20, in particular to a servo motor 21 which adjusts the height of the cutting blade assembly 20 or the cutting blade 22 itself between the main conveyor belt 14 and upper pressing conveyor belt 16, as shown best in FIG. 3. The exact height of the cutting blade 22 of cutting blade assembly 20 is thus set by engagement of the servo motor 21 as determined by the computing device 80 and as meat product 100 approaches the cutting blade 22, the cutting blade engages the meat product 100 to divide the meat product into the top slice 102 and bottom piece 104, as shown best in FIGS. 3 and 4. In the preferred embodiment, the cutting blade assembly 20 would be a bandsaw device, although the exact type of cutting device used in connection with the present invention is not critical so long as the height of the device is adjustable and the meat product 100 is cleanly and efficiently cut.

An important feature of the present invention is that each meat product 100 which is fed through the exact weight meat cutting device 10 is separately weighed and measured to produce the correct cutting location for each meat product 100. Moreover, this is done automatically once the meat product 100 is placed on the main conveyor belt 14 by measurements via the weighing device 50 and the laser displacement sensors 54a and 54b, and thus processing of a great number of separate meat products 100 may proceed quickly and efficiently without needing to readjust or recalibrate the present invention for each and every meat product being fed through the device.

It should be noted that the length of the meat product 100, although determinable by the length of time needed for the meat product 100 to pass by the laser displacement sensors 54a and 54b, as described previously, may also be determined by merely adding the number of measurements taken as the meat product passes by the laser displacement sensors 54a and 54b, as each measurement is taken approximately one millimeter apart. By adding the number of measurements, the exact length of the meat product 100 may be determined. In fact, there are several different ways by which the length and width of the meat product 100 may be determined by use of the laser displacement sensors 54a and 54b, each of which should be understood to be a part of this disclosure and a part of this invention. However, that being said, it has been found that the above-described process of measuring the length and width of the meat product 100 provides a simple, straightforward method by which the length and width of the meat product 100 may be obtained, and therefore its use with the present invention is preferred.

Once the meat product 100 has been cut by the cutting blade 22, the sectioned top slice 102 and exact weight bottom piece 104 are available for further processing as determined by the user of the present invention. It is expected that the bottom piece 104, being of the exact weight predetermined by the operator of the present invention, will be generally ready for packaging and sale, whereas the top slice 102 will undergo further processing, although it will be up to each user of the present invention as to the disposition of the sectioned top slice 102 and exact weight bottom piece 104, and such final use of these is beyond the purview of this disclosure.

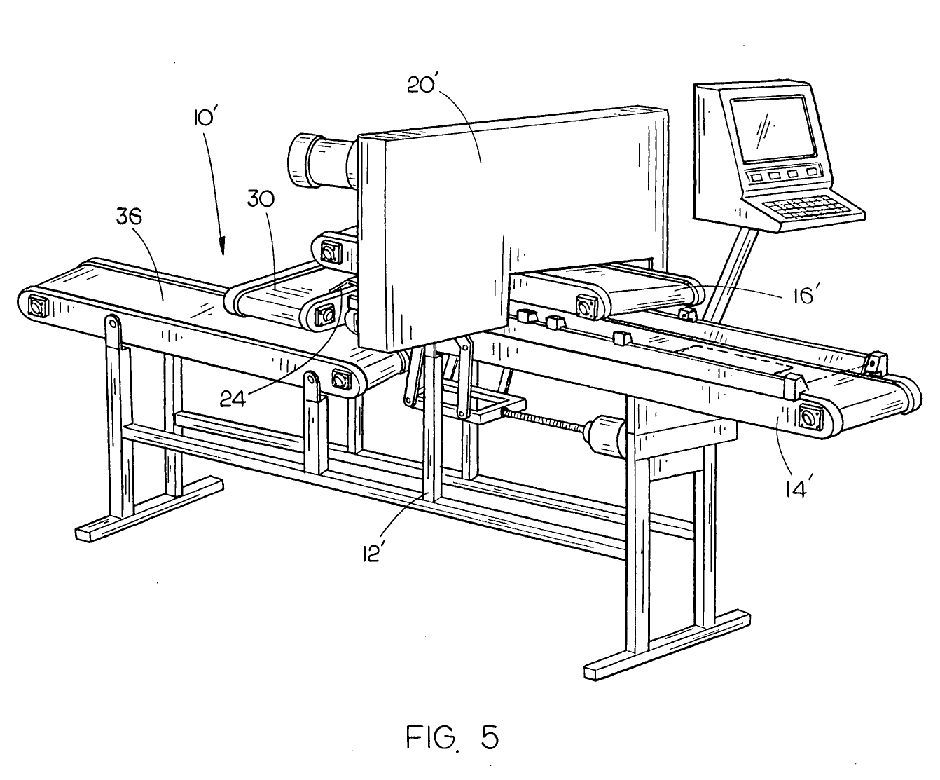

FIGS. 5, 6 and 7 show an alternative embodiment of the exact weight meat cutting device 10′ of the present invention which includes additional belts and mechanisms mounted on the frame 12′ for transferring the top slice 102 and bottom piece 104 for further processing, and is included to disclose one type of device with which the present invention may be used. In the embodiment of FIG. 5, mounted adjacent to and immediately behind the cutting blade 22′ is a separator plate 24 which, in the preferred embodiment, would consist of a generally thin planar piece of high impact plastic such as UHMW or of metal such as stainless steel or the like, which has a generally low coefficient of friction to prevent sticking of the meat product 100, particularly top slice 102 and bottom piece 104, thereto. The separator plate 24 is generally vertically aligned with and vertically movable with the cutting blade 22′ such that vertical adjustment of the cutting blade 22′ by servo motor 21′ between main conveyor belt 14′ and upper pressing conveyor belt 16′ results in vertical adjustment of the separator plate 24 which is mounted directly behind and spaced only a few thousandths of an inch behind the cutting blade 22′. As the meat product 100 is transported between the main conveyor belt 14′ and upper pressing conveyor belt 16′, the cutting blade 22′ divides the top slice 102 from the bottom piece 104 of meat product 100, with the top slice 102 then being disengaged from the meat product 100 by the separator plate 24.

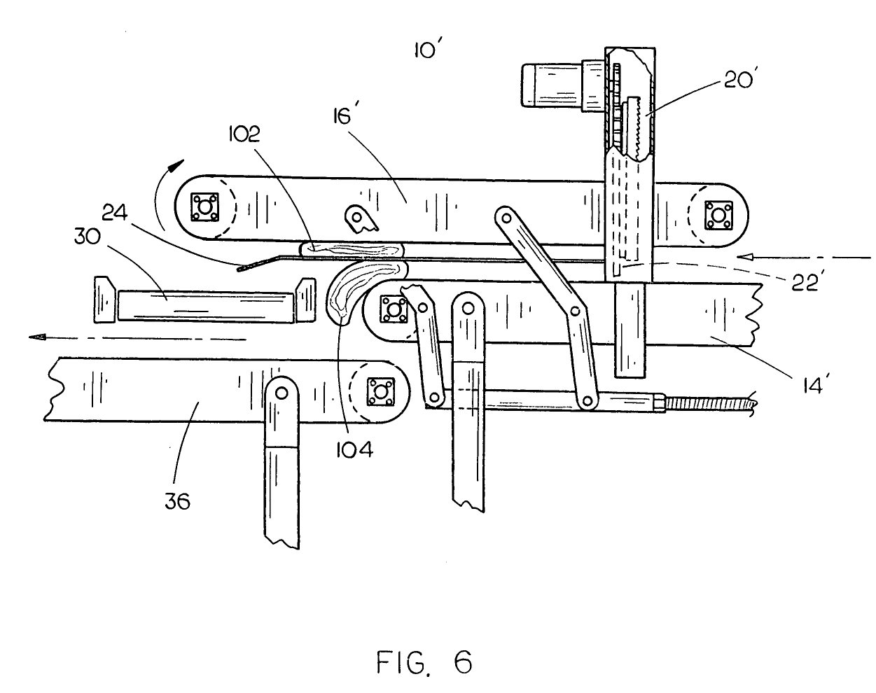

As the meat product 100 with the separated top slice 102 reaches the end of main conveyor belt 14′, the separator plate 24, which extends rearwards from the cutting blade 20′ to generally adjacent the rear end of upper conveyor belt 16′, separates the top slice 102 and bottom piece 104 of meat product 100 with the upper pressing conveyor belt 16′ engaging and moving top slice 102 forwards within the exact weight meat cutting device 10′ and the main conveyor belt 14′ engaging and moving the bottom piece 104 forwards within the exact weight meat cutting device 101. In the preferred embodiment shown in FIG. 5, main conveyor belt 14′ ends forwards of the end of upper pressing conveyor belt 16′ and the bottom piece 104 thus reaches the end of main conveyor belt 14′ prior to top slice 102 reaching the end of upper pressing conveyor belt 16′ and separator plate 24. The bottom piece 104 then falls off of the main conveyor belt 14′ onto a rear conveyor belt 36 which extends rearwards from the main conveyor belt 14′ and is positioned below main conveyor belt 14′ as shown in FIG. 6.

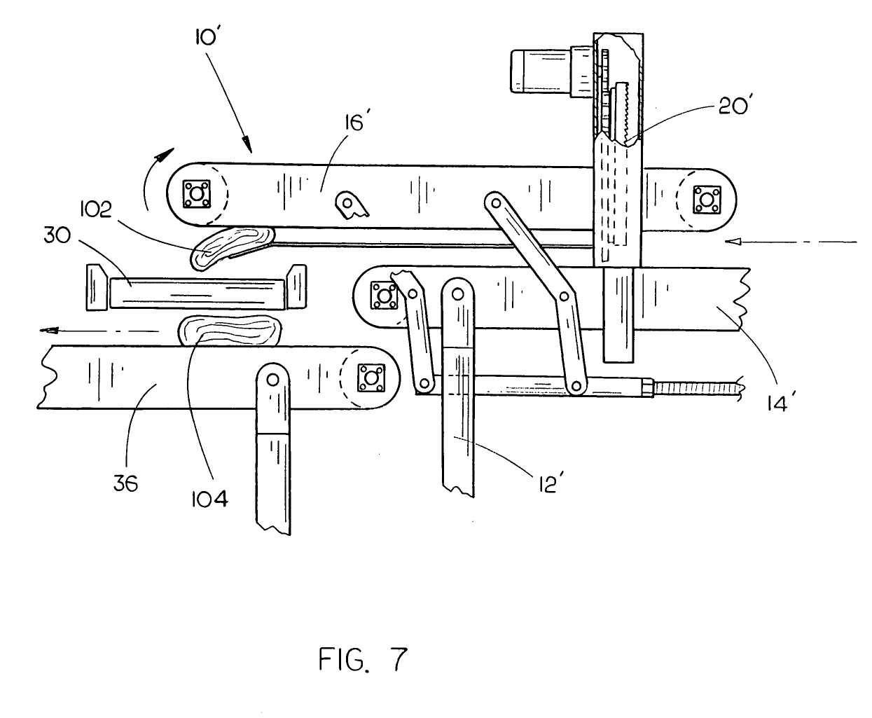

The positioning of the rear conveyor belt 36 is important in that the movement of the bottom piece 104 downwards provides space for the positioning of top slice conveyor belt 30, which is positioned rearwards of main conveyor belt 14′ with a forward portion thereof directly underneath the rearward end of the separator plate 24. As the forward portion of the top slice 102 reaches the end of separator plate 24, as shown in FIG. 7, it falls downwards and lands on top slice removal conveyor belt 30. In the preferred embodiment, the top slice removal conveyor belt 30 would be approximately two to ten feet in length and would extend off to one side of the upper pressing conveyor belt 16′ in order to quickly and simply remove the top slice 102 to a different location for further processing thereof. Of course, the precise location, direction of travel and design of the top slice conveyor belt 30 is not critical to the present invention so long as the forward end of the top slice conveyor belt 30 is positioned beneath the end of the separator plate 24, and the top slice conveyor belt 30 may be modified or changed depending upon the intended top slice transfer characteristics desired in connection with the top slice conveyor belt 30. Once the top slice 102 has been removed from the exact weight meat cutting device 10′ via the top slice conveyor belt 30, the exact weight bottom piece 104, still on rear conveyor belt 36, is available for continued processing.

It is to be understood that numerous additions, substitutions, and modifications may be made to the exact weight meat cutting device 10 of the present invention which fall within the intended broad scope of the above description. For example, the size, shape, and construction materials used in connection with the exact weight meat cutting device 10 may be modified or changed so long as the intended functionality of the various elements is maintained. Furthermore, the programming of computing device 80 may be modified or changed so long as the intended functional features of obtaining the height, length, and width of the meat product 100 are maintained, the computing device 80 then operative to produce a volume measurement for the meat product 100 and determine the precise cutting location on the meat product 100 at which cutting blade 22 is to be applied to produce the predetermined bottom piece 104 weight. Finally, it should be noted that the exact type and positioning of laser displacement sensors 54a and 54b is critical to the present invention only in that each of the laser displacement sensors 54a and 54b must be capable of determining the exact distance between itself and a solid object passing in front of the laser displacement sensors 54a and 54b and permitting sufficient time for the computing device 80 to calculate the correct cutting location and move the cutting blade assembly 20 to the proper height for cutting blade 22 via server motor 21.

There has therefore been shown and described an exact weight meat cutting device 10 which accomplishes at least all of its intended objectives.

We claim:

1. An exact weight meat cutting device comprising:
a frame;
a lower conveyor belt mounted on said frame and having a forward end and a rearward end;
an upper conveyor belt height-adjustably mounted on said frame and extending generally parallel with and spaced above said lower conveyor belt;
weighing means mounted on said frame adjacent said forward end of said lower conveyor belt operative to weigh meat product placed on said lower conveyor belt;
at least two displacement sensors mounted on said frame on opposite sides of said lower conveyor belt, each of said at least two displacement sensors operative to read the length of the meat product from front to back and incrementally read the distance between each of said at least two displacement sensors and an adjacent side of a meat product when the meat product on said lower conveyor belt passes between said at least two displacement sensors;
said lower conveyor belt and said upper conveyor belt cooperating to transport the meat product through said exact weight meat cutting device towards said rearward end of said lower conveyor belt;
computing means in information transmission connection with said weighing means and said at least two displacement sensors, said computing means operative to receive the weight of the meat product, the height between said upper and lower conveyor belts and the incremental distance readings from said at least two displacement sensors and compute the volume of the meat product via calculation of width times length times height for each incremental section of the meat product;
said computing means further operative to determine the amount of meat product which will be cut from the meat product to produce a remainder piece and an exact weight piece, the exact weight piece of the meat product having a selected weight as predetermined by a user of said exact weight meat cutting device;
meat product slicing means intermediate said forward and rearward ends of said lower conveyor belt, said meat product slicing means including position-adjustable blade means, said position-adjustable blade means interposed between said upper conveyor belt and said lower conveyor belt and operative to separate the exact weight piece from the remainder piece of the meat product;
said computing means operatively connected to said meat product slicing means to adjust the positioning of said position-adjustable blade means between said upper conveyor belt and said lower conveyor belt to separate the exact weight piece from the remainder piece of the meat product as determined by said computing means; and
said lower conveyor belt and said upper conveyor belt further cooperating to transport the meat product through said exact weight meat cutting device into contact with and past said adjustable blade means towards said rearward end of said lower conveyor belt whereby the meat product is sliced into the exact weight piece and the remainder piece.

2. The exact weight meat cutting device of claim 1 further comprising a rear conveyor belt means mounted rearwards of said lower conveyor belt and generally adjacent thereto such that upon the remainder piece of the meat product being disengaged from said lower conveyor belt, said rear conveyor belt is operative to engage and transport the remainder piece of the meat product to another location.

3. The exact weight meat cutting device of claim 1 wherein said meat product slicing means comprises a bandsaw and said blade means comprises a bandsaw blade.

4. The exact weight meat cutting device of claim 1 wherein said weighing means comprises a scale mounted directly underneath said lower conveyor belt.

5. The exact weight meat cutting device of claim 1 wherein said at least two displacement sensors each comprise laser displacement sensors operative to identify the leading edge of the meat product as it passes between said laser displacement sensors, incrementally read the distance from an adjacent side of the meat product to the adjacent one of said laser displacement sensors and positioned on opposite sides of the main conveyor belt and identify the trailing edge of the meat product as it passes between said laser displacement sensors whereby the length of the meat product can be calculated.

6. The exact weight meat cutting device of claim 1 wherein said computing means comprises a computer having programmed software operative to compute the volume of meat product to be cut to produce a remainder piece and an exact weight piece, the exact weight piece of the meat product having a selected weight as predetermined by a user of said exact weight meat cutting device and the positioning of the adjustable blade means to obtain the cut.

7. The exact weight meat cutting device of claim 1 further comprising a slice separator plate adjustably mounted on said frame interposed between said upper conveyor belt and said lower conveyor belt and positioned generally rearwardly adjacent and generally vertically movably aligned with said blade means, said top slice separator plate extending rearwards to maintain separation of the exact weight piece and the remainder piece of the meat product.

8. The exact weight meat cutting device of claim 7 wherein said slice separator plate comprises a generally thin planar sheet of substantially low friction material.

9. The exact weight meat cutting device of claim 8 wherein said slice separator plate is positioned rearwards of said blade means between one-thousandth and one half (0.001 and 0.5) inches.

10. An exact weight meat cutting device comprising:
a frame;
a lower conveyor belt mounted on said frame and having a forward end and a rearward end;
an upper conveyor belt height-adjustably mounted on said frame and extending generally parallel with and spaced above said lower conveyor belt;
weighing means mounted on said frame adjacent said forward end of said lower conveyor belt operative to weigh meat product placed on said lower conveyor belt;
meat product length and width measurement means mounted on said frame adjacent said lower conveyor belt, said meat product width measurement means operative to incrementally read the width of the meat product and further operative to read the length of the meat product;
said lower conveyor belt and said upper conveyor belt cooperating to transport the meat product through said exact weight meat cutting device towards said rearward end of said lower conveyor belt;
computing means in information transmission connection with said weighing means and said meat product length and width measurement means, said computing means operative to receive the weight of the meat product, the height between said upper and lower conveyor belts, the incremental width readings from said meat product length and width measurement means and the length of the meat product from said meat product length and width measurement means, and compute the volume of the meat product via calculation of width times length times height for each incremental section of the meat product;
said computing means further operative to determine the amount of meat product which will be cut from the meat product to produce a remainder piece and an exact weight piece, the exact weight piece of the meat product having a selected weight as predetermined by a user of said exact weight meat cutting device;
meat product slicing means intermediate said forward and rearward ends of said lower conveyor belt, said meat product slicing means including position-adjustable blade means, said position-adjustable blade means interposed between said upper conveyor belt and said lower conveyor belt and operative to separate the exact weight piece from the remainder piece of the meat product;
said computing means operatively connected to said meat product slicing means to adjust the positioning of said position-adjustable blade means between said upper conveyor belt and said lower conveyor belt to separate the exact weight piece from the remainder piece of the meat product as determined by said computing means; and
said lower conveyor belt and said upper conveyor belt further cooperating to transport the meat product through said exact weight meat cutting device into contact with and past said adjustable blade means towards said rearward end of said lower conveyor belt whereby the meat product is sliced into the exact weight piece and the remainder piece.

11. The exact weight meat cutting device of claim 10 wherein said meat product length and width measurement means comprises at least two displacement sensors mounted on said frame on opposite sides of said lower conveyor belt, each of said at least two displacement sensors operative to incrementally read the distance between each of said at least two displacement sensors and an adjacent side of a meat product when the meat product on said lower conveyor belt passes between said at least two displacement sensors.

12. The exact weight meat cutting device of claim 10 further comprising a rear conveyor belt means mounted rearwards of said lower conveyor belt and generally adjacent thereto such that upon the remainder piece of the meat product being disengaged from said lower conveyor belt, said rear conveyor belt is operative to engage and transport the remainder piece of the meat product to another location.

13. The exact weight meat cutting device of claim 10 wherein said meat product slicing means comprises a bandsaw and said blade means comprises a bandsaw blade.

14. The exact weight meat cutting device of claim 10 wherein said weighing means comprises a scale mounted directly underneath said lower conveyor belt.

15. The exact weight meat cutting device of claim 11 wherein said at least two displacement sensors each comprise laser displacement sensors operative to identify the leading edge of the meat product as it passes between said laser displacement sensors, incrementally read the distance from an adjacent side of the meat product to the adjacent one of said laser displacement sensors and positioned on opposite sides of the main conveyor belt and identify the trailing edge of the meat product as it passes between said laser displacement sensors whereby the length of the meat product can be calculated.

16. The exact weight meat cutting device of claim 10 wherein said computing means comprises a computer having programmed software operative to compute the volume of meat product to be cut to produce a remainder piece and an exact weight piece, the exact weight piece of the meat product having a selected weight as predetermined by a user of said exact weight meat cutting device and the positioning of the adjustable blade means to obtain the cut.

17. The exact weight meat cutting device of claim 10 further comprising a slice separator plate adjustably mounted on said frame interposed between said upper conveyor belt and said lower conveyor belt and positioned generally rearwardly adjacent and generally vertically movably aligned with said blade means, said top slice separator plate extending rearwards to maintain separation of the exact weight piece and the remainder piece of the meat product.

18. The exact weight meat cutting device of claim 17 wherein said slice separator plate comprises a generally thin planar sheet of substantially low friction material.

19. The exact weight meat cutting device of claim 18 wherein said slice separator plate is positioned rearwards of said blade means between one-thousandth and one half (0.001 and 0.5) inches.

20. An exact weight meat cutting device comprising:
a frame;
a lower conveyor belt mounted on said frame and having a forward end and a rearward end;
an upper conveyor belt height-adjustably mounted on said frame and extending generally parallel with and spaced above said lower conveyor belt, said lower conveyor belt and said upper conveyor belt cooperating to transport the meat product through said exact weight meat cutting device towards said rearward end of said lower conveyor belt;
weighing means mounted on said frame adjacent said forward end of said lower conveyor belt operative to weigh meat product placed on said lower conveyor belt;
meat product length and width measurement means mounted on said frame adjacent said lower conveyor belt, said meat product width measurement means operative to incrementally read the width of the meat product and further operative to read the length of the meat product;
computing means in information transmission connection with said weighing means and said meat product length and width measurement means, said computing means operative to receive the weight of the meat product, the height between said upper and lower conveyor belts, the incremental width readings from said meat product length and width measurement means and the length of the meat product from said meat product length and width measurement means, and compute the volume of the meat product via calculation of width times length times height for each incremental section of the meat product;
said computing means further operative to determine the amount of meat product which will be cut from the meat product to produce a remainder piece and an exact weight piece, the exact weight piece of the meat product having a selected weight as predetermined by a user of said exact weight meat cutting device;
meat product slicing means including position-adjustable blade means, said position-adjustable blade means interposed between said upper conveyor belt and said lower conveyor belt and operative to separate the exact weight piece from the remainder piece of the meat product; and
said computing means operatively connected to said meat product slicing means to adjust the positioning of said position-adjustable blade means between said upper conveyor belt and said lower conveyor belt to separate the exact weight piece from the remainder piece of the meat product as determined by said computing means.
